(19) United States
(12) Patent Application Publication
(10) Pub. No.: US 2008/0152276 A1
(43) Pub. Date: Jun. 26, 2008

(54) Unitized Clutch Bearing Assembly

(75) Inventors: Ian D. Baynes, Simpsonville, SC (US); Kenneth Anderson, Torrington, CT (US); David R. Moulton, Barkhamsted, CT (US)

Correspondence Address: MICHAEL BEST & FRIEDRICH LLP, 100 E WISCONSIN AVENUE, Suite 3300, MILWAUKEE, WI, 53202, US

(73) Assignee: TIMKEN US CORPORATION, Torrington, CT (US)

(21) Appl. No.: 11/815,827

(22) PCT Filed: Feb. 3, 2006
(86) PCT No.: PCT/US06/04080

§ 371 Date: Aug. 8, 2007

Related U.S. Application Data
(60) Provisional application No. 60/654,973, filed on Feb. 22, 2005.

(51) Int. Cl. F16C 33/58; B21D 53/10

(52) U.S. Cl. 384/569; 29/898.061

(57) ABSTRACT

The present invention provides a clutch bearing assembly including a split outer cylindrical race having opposed axial edges. One outer race axial edge includes a radially inwardly-extending flange having an inner diameter Y. The clutch bearing assembly also includes an inner cylindrical race having opposed axial edges. One inner race axial edge includes a first radially outwardly-extending flange and the opposite inner race axial edge includes a second radially outwardly-extending flange. The second radially outwardly-extending flange has an outer diameter X greater than inner diameter Y such that the second radially outwardly-extending flange radially overlaps the outer race radially inwardly-extending flange. The clutch bearing assembly also includes a plurality of ramps formed on at least one of the outer cylindrical race and the inner cylindrical race. The ramps at least partially define roller pockets. The clutch bearing assembly further includes a plurality of rollers positioned in the roller pockets.

### RELATED APPLICATIONS

This application claims priority to U.S. Provisional Patent Application Ser. No. 60/654,973 filed on Feb. 22, 2005, the entire contents of which is incorporated herein by reference.

### FIELD OF THE INVENTION

The present invention relates to a clutch assembly which engages upon positive torque being provided by an input member to transfer the torque to an output member.

### BACKGROUND OF THE INVENTION

Roller/ramp clutch assemblies are used in a wide variety of applications. One possible application is an automatic locking hub or transfer case differential of a four-wheel drive vehicle. During operation of four-wheel drive vehicles, it is often desirable to disconnect the alternate drive wheels (usually the front wheels) of the vehicle from the remainder of the drive train. When disconnected, the alternate drive wheels can rotate freely with respect to the drive train and, accordingly, they are free to rotate without regard to the rotational speed of the drive train. At other times, it is preferred that the alternate drive wheels of the vehicle automatically lock to the drive train whenever there is relative disproportional rotation between the alternate drive wheels and the input member from the drive train. Roller/ramp clutch assemblies have also been provided where the clutch assembly transfers torque in only one direction and where the torque can be transferred in two directions.

Roller/ramp clutch assemblies generally include concentric driving and driven members with the driving member having axial surfaces which face radially toward the other member. Upon each surface, a roller is loosely held. The rollers are inertially responsive to acceleration of the driving member and when rotational acceleration of the driving member occurs, the inertia of the rollers causes them to move along the surfaces toward a side edge of the surfaces. At the side edge, the distance between these surfaces and the driven member is less than the diameter of the roller and the roller contacts the driven member becoming engaged or locked in the wedge formed between the axial surfaces of the driving member and the circumference of the driven member. In some varieties, the rollers can move along the axial surfaces to either side. In other varieties, engagement with the driven member is only possible by movement of the roller to one side of the surface.

### SUMMARY OF THE INVENTION

The driving and driven members are typically mounted within or about a respective housing or shaft upon assembly. The mounting relative to the housing and shaft serve to limit axial movement of the members. It is desirable to provide a clutch assembly that is unitized prior to assembly such that the assembly can be shipped and handled as a unitized assembly.

The present invention provides, in one aspect, a clutch bearing assembly including a split outer cylindrical race having opposed axial edges. One outer race axial edge includes a radially inwardly-extending flange having an inner diameter Y. The clutch bearing assembly also includes an inner cylindrical race having opposed axial edges. One inner race axial edge includes a first radially outwardly-extending flange and the opposite inner race axial edge includes a second radially outwardly-extending flange. The second radially outwardly-extending flange has an outer diameter X greater than inner diameter Y such that the second radially outwardly-extending flange radially overlaps the outer race radially inwardly-extending flange. The clutch bearing assembly also includes a plurality of ramps formed on at least one of the outer cylindrical race and the inner cylindrical race. The ramps at least partially define roller pockets. The clutch bearing assembly further includes a plurality of rollers positioned in the roller pockets.

The present invention provides, in another aspect, a method of manufacturing a clutch bearing assembly. The method includes forming an outer cylindrical race having opposed axial edges through a drawing process, forming a radially inwardly-extending flange on one axial edge of the outer cylindrical race, the radially inwardly-extending flange having an inner diameter Y, forming an inner cylindrical race having opposed axial edges through a drawing process, positioning a plurality of rollers between the inner cylindrical race and the outer cylindrical race, forming a first radially outwardly-extending flange on one axial edge of the inner cylindrical race, and forming a second radially outwardly-extending flange on the opposite axial edge of the inner cylindrical race. The second radially outwardly-extending flange has an outer diameter X greater than the inner diameter Y such that the second radially outwardly-extending flange radially overlaps the outer race radially inwardly-extending flange.

Other features and aspects of the invention will become apparent by consideration of the following detailed description and accompanying drawings.

### BRIEF DESCRIPTION OF THE DRAWINGS

FIG. 1 is an isometric view of a clutch bearing assembly according to a first embodiment of the present invention.

FIG. 2 is a front elevation view of the clutch bearing assembly of FIG. 1.

FIG. 3 is a cross-sectional view of the clutch bearing assembly of FIG. 1 along the line 3-3 in FIG. 2.

FIG. 4 is a partial rear elevation view of the clutch bearing assembly of FIG. 1 along the line 4-4 in FIG. 3.

FIG. 5 is a partial cross-sectional view similar to FIG. 3 showing an alternate embodiment of the present invention.

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

### DETAILED DESCRIPTION

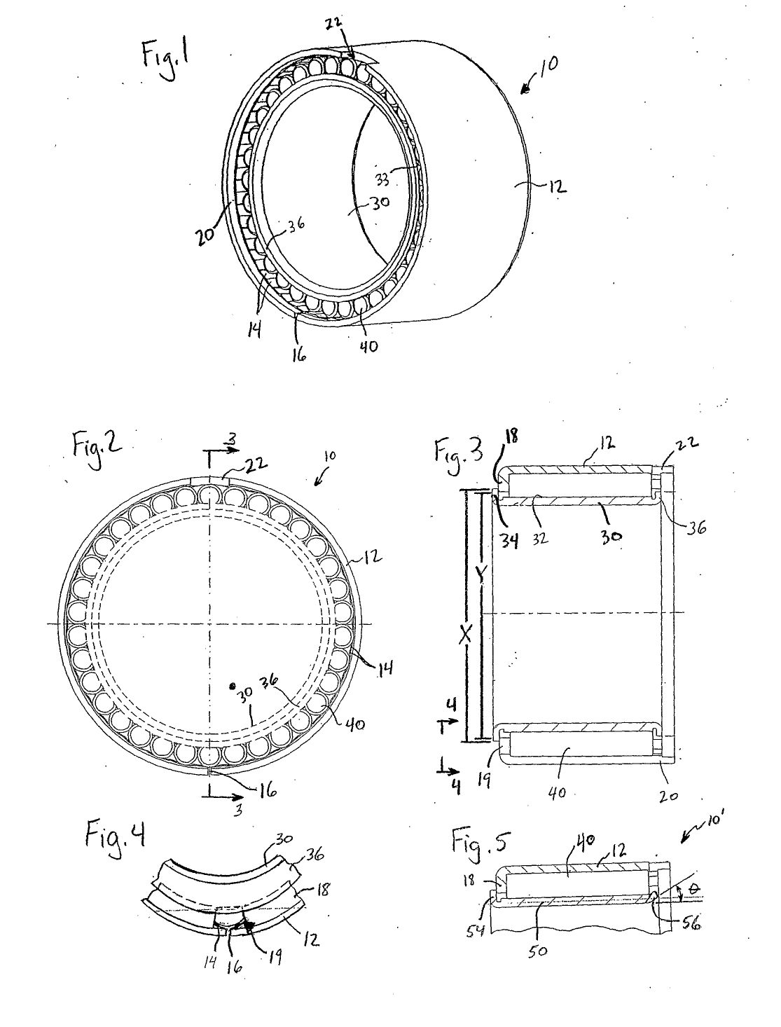

Referring to FIGS. 1-4, a clutch bearing assembly 10 that is a first embodiment of the present invention is shown. The clutch bearing assembly 10 generally comprises an outer race 12, an inner race 30 and a plurality of rollers 40. The outer race 12 is a cylindrical tube with an axial split 16 such that the outer race 12 is expandable as will be explained hereinafter. The outer race 12 has an inner surface with a plurality of ramps 14. The ramps 14 define pockets into which the rollers 40 are placed. The inner race 30 is a solid cylindrical tube having an outer bearing surface 32. The outer bearing surface 32 preferably has ramps 33 opposed to the outer race ramps 14 to further define the roller pockets. The illustrated embodiment includes a full complement of rollers 40, however, the rollers 40 may alternatively be retained by a cage or the like.

To axially retain the rollers 40 within the space between the outer and inner races 12, 30, the outer race 12 has a radially inwardly-extending flange 18 at one axial edge thereof and the opposite edge of the inner race 30 has a radially outwardly-extending flange 36. As can be seen in FIG. 3, the rollers 40 are axially retained by the outer race inwardly-extending flange 18 and the inner race outwardly-extending flange 36. To unitize the assembly 10, the inner race 30 includes a second outwardly-extending flange 34 at its opposite axial edge. The outwardly-extending flange 34 has an outer diameter X that is greater than the inner diameter Y of the outer race inwardly-extending flange 18 such that the outwardly-extending flange 34 radially overlaps the inwardly-extending flange 18. The outer race 12 is thereby axially retained between the outwardly-extending flange 34 and the roller 40. The roller 40 in turn is axially retained at the opposite end by the outwardly-extending flange 36 such that the clutch bearing assembly 10 is retained as a unitized structure.

Referring to FIGS. 3 and 4, to facilitate the axial split 16 in the outer race 12, the outer race inwardly-extending flange 18 has a tapered cutout 19 corresponding with or generally aligned with the split 16. The cutout 19 preferably has a width that is less than the diameter of one of the rollers 40. The cutout 19 is preferably provided by a profiled punch to prevent pinching of the split 16. The opposite axial edge of the outer race 12 includes an axially extending lip 20. The lip 20 preferably extends axially beyond the rollers 40. The lip 20 is provided with a notch 22 to facilitate alignment of the clutch bearing assembly 10. This configuration allows alignment utilizing the outer race 12, which is often easier to facilitate.

In the preferred method of assembly, the outer race 12 is formed through a drawing process. The inwardly-extending flange 18 is preferably formed during the drawing process. The inner race 30 is also preferably formed using a drawing process. To facilitate insertion of the rollers 40, one or both of the flanges 34, 36 are drawn as straight lips and are bent or curled over after assembly. To assist in the bending or curling, the flanges 34, 36 are preferably formed with a reduced thickness. After bending or curling, the clutch bearing assembly 10 is a unitized assembly. Alternatively, the inner race 30 may be formed with both flanges 34, 36. The rollers 40 are positioned about the inner race 30 and the axial split 16 allows the outer race 12 to be snapped over the rollers 40 and inner race 30.

Referring to FIG. 5, a clutch bearing assembly 10′ that is a second embodiment of the present invention is shown. The clutch bearing assembly 10′ is similar to that of the first embodiment and includes an outer race 12, an inner race 50 and a plurality of rollers 40. The outer race 12 is essentially the same as in the first embodiment and includes a radially inwardly-extending flange 18. The inner race 50 is similar to the first embodiment and includes a radially outward flange 54 that radially overlaps the outer race inwardly-extending flange 18 to unitize the assembly 10′. The opposite edge of the inner race 50 includes a flange 56. As shown in FIG. 5, the flange 56 extends at an acute angle θ that is less than 90°. The angle θ is such that the flange 56 extends sufficiently radially outwardly to axially retain the rollers 40. In other constructions, the angle θ can be larger than 90°.

Various features of the invention are set forth in the following claims.

What is claimed is:

1. A clutch bearing assembly comprising:
a split outer cylindrical race having opposed axial edges, one outer race axial edge including a radially inwardly-extending flange, the radially inwardly-extending flange having an inner diameter Y;
an inner cylindrical race having opposed axial edges, one inner race axial edge having a first radially outwardly-extending flange and the opposite inner race axial edge including a second radially outwardly-extending flange, the second radially outwardly-extending flange having an outer diameter X greater than inner diameter Y such that the second radially outwardly-extending flange radially overlaps the outer race radially inwardly-extending flange;
a plurality of ramps formed on at least one of the outer cylindrical race and the inner cylindrical race, the ramps at least partially defining roller pockets; and
a plurality of rollers positioned in the roller pockets.

2. The clutch bearing assembly of claim 1, wherein the first radially outwardly-extending flange forms an acute angle with respect to the inner cylindrical race.

3. The clutch bearing assembly of claim 1, wherein the inner cylindrical race is axially constrained in a first direction by the rollers, and in a second direction by the radially inwardly-extending flange of the outer cylindrical race.

4. The clutch bearing assembly of claim 1, wherein the outer cylindrical race is axially constrained in a first direction by the rollers, and in a second direction by the second radially outwardly-extending flange of the inner cylindrical race.

5. The clutch bearing assembly of claim 1, wherein the rollers are axially constrained in a first direction by the first radially outwardly-extending flange of the inner cylindrical race, and in a second direction by the radially inwardly-extending flange of the outer cylindrical race.

6. The clutch bearing assembly of claim 1, wherein the outer cylindrical race includes an axial split, and wherein the radially inwardly-extending flange of the outer cylindrical race includes a cutout generally aligned with the axial split.

7. The clutch bearing assembly of claim 6, wherein the cutout has a width less than a diameter of the rollers.

8. The clutch bearing assembly of claim 1, wherein a second of the opposed axial edges of the outer cylindrical race defines a generally straight, axially-extending lip.

9. The clutch bearing assembly of claim 8, wherein the axially-extending lip on the outer cylindrical race includes a notch.

10. The clutch bearing assembly of claim 1, wherein the ramps are formed on facing surfaces of the outer cylindrical race and the inner cylindrical race.

11. A method of manufacturing a clutch bearing assembly, the method comprising:
forming an outer cylindrical race having opposed axial edges by a drawing process;
forming a radially inwardly-extending flange on one axial edge of the outer cylindrical race, the radially inwardly-extending flange having an inner diameter Y;
forming an inner cylindrical race having opposed axial edges by a drawing process;
positioning a plurality of rollers between the inner cylindrical race and the outer cylindrical race;
forming a first radially outwardly-extending flange on one axial edge of the inner cylindrical race; and
forming a second radially outwardly-extending flange on the opposite axial edge of the inner cylindrical race, the second radially outwardly-extending flange having an outer diameter X greater than the inner diameter Y such that the second radially outwardly-extending flange radially overlaps the outer race radially inwardly-extending flange.

12. The method of claim 9, wherein forming the first and second radially outwardly-extending flanges on the inner cylindrical race occurs before positioning the plurality of rollers between the inner cylindrical race and the outer cylindrical race.

13. The method of claim 9, wherein forming the first and second radially outwardly-extending flanges on the inner cylindrical race occurs after positioning the plurality of rollers between the inner cylindrical race and the outer cylindrical race.

14. The method of claim 9, wherein positioning the plurality of rollers between the inner cylindrical race and the outer cylindrical race occurs after forming the second radially outwardly-extending flange of the inner cylindrical race, and wherein forming the first radially outwardly-extending flange of the inner cylindrical race occurs after positioning the plurality of rollers between the inner cylindrical race and the outer cylindrical race.

15. The method of claim 9, wherein forming the first and second radially outwardly-extending flanges includes forming the first and second radially outwardly-extending flanges with a reduced thickness.

16. The method of claim 9, further comprising forming an axial split in the outer cylindrical race.

17. The method of claim 16, further comprising forming a cutout in the radially inwardly-extending flange of the outer cylindrical race generally aligned with the axial split.

18. The method of claim 9, further comprising forming a notch in the outer cylindrical race.

19. The method of claim 18, wherein forming the notch in the outer cylindrical race includes forming the notch in the axial edge of the outer cylindrical race opposite the radially inwardly-extending flange.

20. The method of claim 9, wherein forming the first radially outwardly-extending flange includes forming the first radially-outward extending flange at an acute angle with respect to the inner cylindrical race.
